(19) United States
(12) Patent Application Publication
(10) Pub. No.: US 2025/0389540 A1
(43) Pub. Date: Dec. 25, 2025

(54) TOPOLOGY MAP-BASED USER LOCATION ESTIMATION APPARATUS AND METHOD

(71) Applicants: HYUNDAI MOTOR COMPANY, Seoul (KR); Kia Corporation, Seoul (KR)

(72) Inventors: Kyungzun RIM, Hwaseong-si (KR); Hotaek HAN, Hwaseong-si (KR)

(21) Appl. No.: 18/931,391

(22) Filed: Oct. 30, 2024

(30) Foreign Application Priority Data
Jun. 19, 2024 (KR) 10-2024-0079639

(51) Int. Cl. G01C 21/30; G06T 7/70; G06V 30/12

(52) U.S. Cl. CPC G01C 21/30; G06T 7/70; G06V 30/133

(57) ABSTRACT

A topology map-based user location estimation apparatus includes an Optical Character Recognition (OCR) module, an OCR filter, and a location finding module. The OCR module is configured to recognize characters from an image of an environment surrounding a user. The OCR filter is configured to, based on a similarity determination with location information stored in a topology map that is generated based on a guide map image, filter one or more characters from the recognized characters. The location finding module is configured to, based on the filtered one or more characters, detect a current location of the user on the topology map.

### CROSS-REFERENCE TO RELATED APPLICATION

This application claims priority to and the benefit of Korean Patent Application No. 10-2024-0079639, filed on Jun. 19, 2024, the disclosure of which is incorporated herein by reference in its entirety.

### TECHNICAL FIELD

The present disclosure relates to a topology map-based user location estimation apparatus and method. More particularly, the present disclosure relates to a topology map-based user location estimation apparatus and method capable of estimating a user location on the topology map from a user's surrounding image.

### BACKGROUND

Indoor location estimation technology may entail significant initial costs to provide users with low-error-range location information.

Available applications or technologies may create precise maps to provide accurate location information or may estimate a person's location using an indoor Wi-Fi intermediary. Services based on the precise maps may necessitate data collection by physically visiting the space where the service will be provided. This approach may be costly and time-consuming (e.g., to create maps), which may limit the ability to expand services to new areas. Since people generally do not face difficulties in determining their current location even when they only know the approximate location, there may be no need to estimate the exact location, e.g., within 5 cm that a typical precise map provides.

Additionally, the method of determining a location via Wi-Fi intermediary may entail an installation of the intermediary, which may limit the ability to quickly apply the technology in new spaces.

### SUMMARY

The present disclosure attempts to provide a topology map-based user location estimation apparatus and method capable of identifying a position of a person or a robot on the topology map generated from a guide map by using only an image including surrounding characters without creating a map in advance in a wide indoor space or service spot.

A topology map-based user location estimation apparatus can include a topology map generated based on a guide map image, an OCR module configured to recognize characters from a user's surrounding image provided by a user, an OCR filter configured to filter some characters from recognized character through similarity determination with location information stored in the topology map, and a location finding module configured to detect a current location of the user on the topology map based on a final character obtained through the OCR filter.

The OCR module can be configured to detect the character, a coordinate of a pixel where the character is located and a confidence of a recognition result in the user's surrounding image by utilizing an artificial intelligence.

The topology map can include a vertex storing the location information obtained from the guide map image through character recognition using an image processing and OCR and the edge connecting the vertices.

The location finding module can be configured to extract a specific vertex estimated as the current location of the user from the vertices included in the topology map.

The OCR filter can be configured to detect similarity of the location information between the recognized character and the topology map through

Equation 1 below,

$$Similarity ( character 1 , character 2 ) = 1 - \frac{Edit Distance ( character 1 , character 2 )}{Max ( L ( character 1 ) , L ( character 2 ) )} \qquad [ Equation 1 ]$$

where, character1 denotes characters recognized by OCR, character2 denotes location information stored in the topology map, Edit Distance denotes an edit distance algorithm measuring similarity between character1 and character2, and L is a function for obtaining the length of the character.

The OCR filter can be configured to determine a character of which the detected similarity is greater than or equal to a preset specific level as the final character.

The location finding module can be configured to determine a reference vertex on the topology map having location information matching the final character, and determine a plurality of surrounding vertices that are within a predetermined distance from the reference vertex.

The location finding module can be configured to determine the predetermined distance in proportion to a size of the guide map image.

The location finding module can be configured to determine the surrounding vertices as a current location candidate of the user, and calculate the probability by using Equation 2 for each of the determined current location candidates, respectively,

$$Probability = \frac{( number of reference pixels - distance to vertez storing word )}{number of reference pixels} \times confidence \qquad [ Equation 2 ]$$

where, probability is the probability that the current location candidate is an actually current location, the number of reference pixels represents the predetermined distance between the reference vertex and the surrounding vertex, a distance to a vertex storing a word represents a distance of a corresponding current location candidate to the reference vertex, and confidence represents a confidence of an OCR recognition result.

The location finding module can be configured to detect the specific vertex having the highest probability among the current location candidates as the actual current location of the user.

A topology map-based user location estimation method can include providing the topology map generated based on a guide map image, recognizing characters from a user's surrounding image provided by a user, filtering some characters from recognized character through similarity determination with location information stored in the topology map, to obtain a final character, and detecting a current location of the user on the topology map based on the final character.

The recognizing the character can include detecting the character, a coordinate of a pixel where the character is located, and a confidence of a recognition result in the user's surrounding image by utilizing an artificial intelligence.

The topology map can include the vertex storing location information obtained from the guide map image through image processing and character recognition using OCR and the edge connecting the vertices.

The detecting the current location of the user can include extracting a specific vertex estimated as the current location of the user from the vertices included in the topology map.

The filtering can include detecting similarity of the location information between the recognized character and the topology map through Equation 1,

$$Similarity ( character 1 , character 2 ) = 1 - \frac{Edit Distance ( character 1 , character 2 )}{Max ( L ( character 1 ) , L ( character 2 ) )} \qquad [ Equation 1 ]$$

Here, character1 is character recognized by OCR, character2 denotes location information stored in the topology map, Edit Distance denotes an edit distance algorithm measuring similarity between character1 and character2, and L is a function for obtaining the length of the character.

The filtering further can include determining a character of which the detected similarity is greater than or equal to a preset specific level as the final character.

The detecting the current location of the user further can include determining a reference vertex on the topology map having location information matching the final character, and determining a plurality of surrounding vertices that are within a predetermined distance from the reference vertex.

The detecting the current location of the user further can include determining the predetermined distance in proportion to a size of the guide map image.

The detecting the current location of the user can further include determining the surrounding vertices as a current location candidate of the user, and calculating each probability by using Equation 2 below for each of the determined current location candidates,

$$Probability = \frac{( number of reference pixels - distance to vertez storing word )}{number of reference pixels} \times confidence \qquad [ Equation 2 ]$$

where, probability is the probability that the current location candidate is an actually current location, the number of reference pixels represents the predetermined distance between the reference vertex and the surrounding vertex, a distance to a vertex storing a word represents a distance of a corresponding current location candidate to the reference vertex, and confidence represents a confidence of an OCR recognition result.

The detecting the current location of the user can further include detecting the specific vertex having the highest probability among the current location candidates as the actual current location of the user.

A topology map-based user location estimation apparatus and method can identify a position of a person or a robot on the topology map generated from a guide map by using only an image including surrounding characters without creating a map in advance in a wide indoor space or service spot.

According to a topology map-based user location estimation apparatus and method, since the advantage that the change of the topology map can be promptly reflected can be utilized, the current location finding service can be provided to the users at a low cost in fairs, conferences, and exhibition halls held for a short period of time or indoor environment having many stores having frequently changing surrounding environment.

### BRIEF DESCRIPTION OF THE DRAWINGS

FIG. 1 schematically shows an example of a topology map system.

FIG. 2 is a block diagram of an example of a topology map-based user location estimation apparatus.

FIG. 3 is a flowchart of an example of a topology map-based user location estimation method.

FIG. 4 is an illustration for explaining an example of a topology map-based user location estimation method according to an implementation of FIG. 3.

FIG. 5 is a flowchart of an example of a topology map-based user location estimation method.

FIG. 6A and FIG. 6B are example diagrams for explaining a topology map-based user location estimation method.

FIG. 7 is an illustration for explaining an example of a computing device . . .

### DETAILED DESCRIPTION

An implementation of the disclosure will be described more fully hereinafter with reference to the accompanying drawings. As those skilled in the art would realize, the described implementations can be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which can be implemented by hardware, software, or a combination of hardware and software.

Hereinafter, implementations of the present disclosure will be described with reference to the drawings.

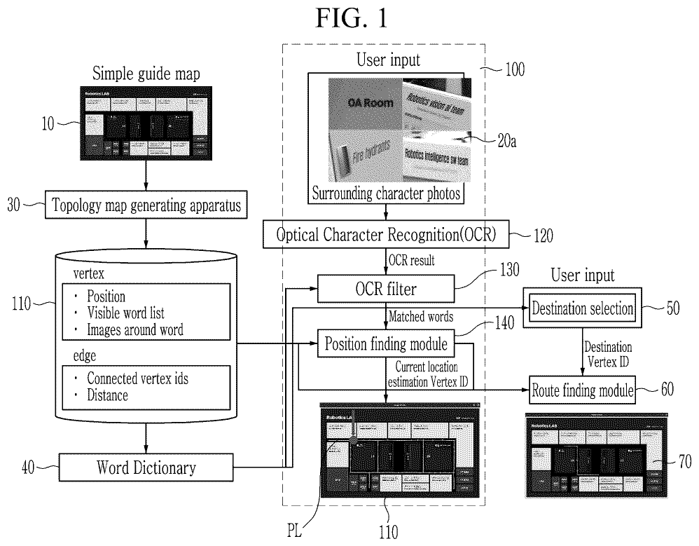

FIG. 1 schematically shows a topology map system.

When the user provides surrounding character photos or a user's surrounding image 20a into the user input through an application or the like in a topology map system, a topology map-based user location estimation apparatus 100 can recognize characters through an OCR module 120, find matched characters through an OCR filter 130, and based on these, estimate a current location PL of the user in a topology map 110 through a location finding module 140.

Furthermore, when the user inputs a destination selection 50, the topology map system can provide a topology map-based route 70 through a route finding module 60 based on the estimated current location PL of the user.

In FIG. 1, a topology map generating apparatus 30 can generate the topology map from a simple guide map image 10.

The topology map generating apparatus 30 can create the topology map 110 enabling location finding and route finding services by using the simple guide map.

The topology map generating apparatus 30 can operate offline and on a server. The greatest difference from the existing precise map creation lies in that a map enabling the location estimation and route finding services for people can be created without collecting the sensor data at the service site.

The topology map generating apparatus 30 can be configured as a process of creating a vertex and an edge and a process of inputting location information. The topology map generating apparatus 30 includes an automatic mode and a manual mode in each of the two above processes.

In the automatic mode, the topology map generating apparatus 30 can recognize the characters from a guide map 10 by using the OCR module 120, extract a polygon by using an image processing technique to automatically create the vertex and the edge, and store location information in the created topology map 110 the recognition result of by using the OCR module 120.

In the manual mode, the topology map generating apparatus 30 can provide an interface for generating and/or modifying the topology map 110 to the user.

The topology map generating apparatus 30 can store the location information in the vertex of the topology map 110. For example, the topology map generating apparatus 30 can store location information, word lists, image around words, or the like, of the location, in the vertex of the topology map 110.

The topology map generating apparatus 30 can store a distance between vertices, information of the connected vertices, or the like, in the edge of the topology map 110.

In some implementations, the topology map 110 can store the location information in a word dictionary 40. The word dictionary 40 can store a word matching the location information stored in the vertex in Korean and English.

In FIG. 1, the topology map-based user location estimation apparatus 100 can inform a position of a person or a robot by using the topology map created based on the guide map.

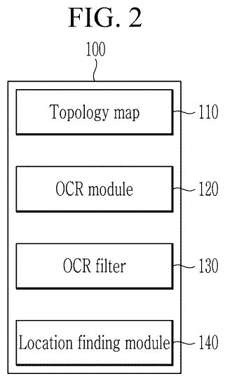

FIG. 2 is a block diagram of a topology map-based user location estimation apparatus.

Referring to FIG. 2, the topology map-based user location estimation apparatus 100 can include the topology map 110, the OCR module 120, the OCR filter 130 and the location finding module 140.

The topology map 110 can be generated based on the guide map image 10 (see FIG. 1) through the topology map generating apparatus 30 (see FIG. 1). The topology map 110 can include a vertex storing the location information and an edge connecting the vertices. The vertex can be estimated by a location of the user, and the edge can configure a route along which the user moves.

The OCR module 120 can recognize characters from the user's surrounding image provided by a user.

The OCR module 120 can detect not only the character, but also the coordinate of the pixel where the character is located and the confidence of the recognition result, from the user's surrounding image, by utilizing an artificial intelligence.

The OCR filter 130 can filter out some characters from recognized character through similarity determination with the location information stored in the topology map, and detect a final character.

That is, the OCR filter 130 can compare the recognized character with words representing the location information stored in the word dictionary possessed by the topology map, and thereby can filter a character recognition result meaningful for the user location estimation.

Through Equation 1, the OCR filter 130 can detect similarity of the location information between the recognized character and the topology map.

$$Similarity ( character 1 , character 2 ) = 1 - \frac{Edit Distance ( character 1 , character 2 )}{Max ( L ( character 1 ) , L ( character 2 ) )} \qquad [ Equation 1 ]$$

Here, character1 denotes characters recognized by OCR in the user's surrounding image, character2 denotes the location information stored in the topology map, Edit Distance denotes an edit distance algorithm measuring similarity between character1 and character2, and L is a function for obtaining the length of respective characters.

The OCR filter 130 can determine a character of which the detected similarity is greater than or equal to a preset specific level, as the final character. The location finding module 140 can detect the current the location of the user on the topology map based on the final character obtained through the OCR filter.

That is, the location finding module 140 can find a vertex closest to the current location of a person or a robot by using the character recognition result filtered out through the OCR filter 130 and the topology map.

The location finding module 140 can extract a specific vertex estimated as the current the location of the user from vertex included the topology map.

The location finding module 140 can determine a reference vertex on the topology map having the location information matching the final character.

The location finding module 140 can determine a plurality of surrounding vertices that are within a predetermined distance from the reference vertex.

The location finding module 140 can determine the predetermined distance, which is a basis for determining the surrounding vertices in proportion to a size of the guide map image.

The location finding module 140 can determine the surrounding vertices as a current location candidate of the user, and calculate the probability by using Equation 2 for each of the determined current location candidates, respectively.

$$Probability = \frac{( number of reference pixels - distance to vertez storing word )}{number of reference pixels} \times confidence \qquad [ Equation 2 ]$$

Here, probability is the probability that the current location candidate is an actually current location, the number of reference pixels represents the predetermined distance of between the reference vertex and the surrounding vertex by pixel unit, a distance to a vertex storing a word represents a distance of a corresponding current location candidate to the reference vertex, and confidence represents a confidence of an OCR recognition result.

The location finding module 140 can detect the specific vertex having the highest probability among the current location candidates as the actual current the location of the user.

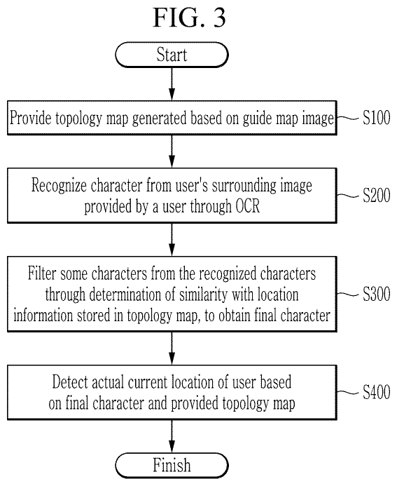

FIG. 3 is a flowchart of a topology map-based user location estimation method. The topology map-based user location estimation method of FIG. 3 can be performed through the topology map-based user location estimation apparatus 100 (see FIG. 2).

In FIG. 3, at step S100, the topology map-based user location estimation apparatus 100 can provide the topology map generated based on the guide map image.

The topology map can include the vertex storing the location information obtained from the guide map image through the image processing and character recognition using OCR and the edge connecting the vertices.

At step S200, the topology map-based user location estimation apparatus 100 can recognize character from the user's surrounding image provided by a user through OCR.

The topology map-based user location estimation apparatus 100 can detect not only the characters but also the coordinate of the pixel where the character is located and the confidence of the recognition result from the user's surrounding image by utilizing the artificial intelligence (e.g., deep learning).

At step S300, the topology map-based user location estimation apparatus 100 can filter some characters from the recognized characters through similarity determination with the location information stored in the topology map, to obtain the final character.

The topology map-based user location estimation apparatus 100 can determine a character of which the detected similarity is greater than or equal to a preset specific level, as the final character.

At step S400, the topology map-based user location estimation apparatus 100 can detect the actual current the location of the user based on the final character and the provided topology map.

That is, the topology map-based user location estimation apparatus 100 can extract the specific vertex estimated as the current the location of the user from vertex included the topology map.

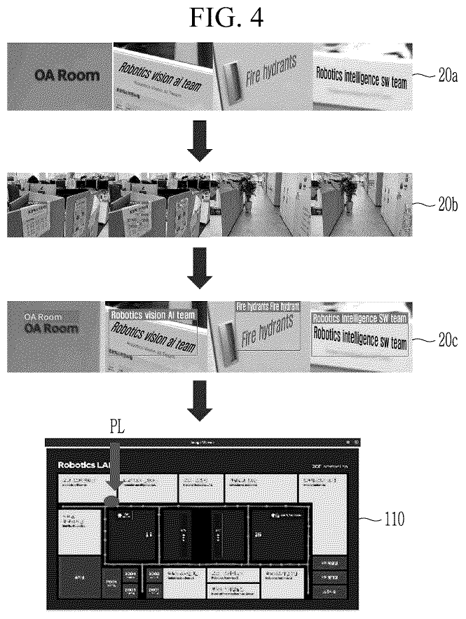

FIG. 4 is a drawing for explaining a topology map-based user location estimation location estimation method according to an implementation of FIG. 3.

In FIG. 4, according to the topology map-based user location estimation method, the user's surrounding image 20a can be provided as a user input 20a. The user can photograph and upload a sign board, sign, or the like, around the user, to provide the user surrounding character photo as the user input 20a.

Thereafter, an OCR result image 20b can be generated through character recognition and character position detection using the OCR module 30 from the user input 20a. The OCR result image 20b can recognize all characters and character positions included in the user surrounding photo.

Thereafter, through the OCR filter 40, only necessary characters can be extracted from the OCR result image 20b, and other characters are filtered out, to generate the OCR filter result image 20c. The OCR filter result image 20c can only include characters matching the characters stored in the topology map (or word dictionary of the topology map) excluding unnecessary characters from the OCR result image 20b.

According to the topology map-based user location estimation method, the user current location PL can be derived as the final result on the topology map 110 from the OCR filter result image 20c. That is, the finally detected user current location PL can be detected as the specific vertex on the topology map storing the location information matching the character of the OCR result image 20b.

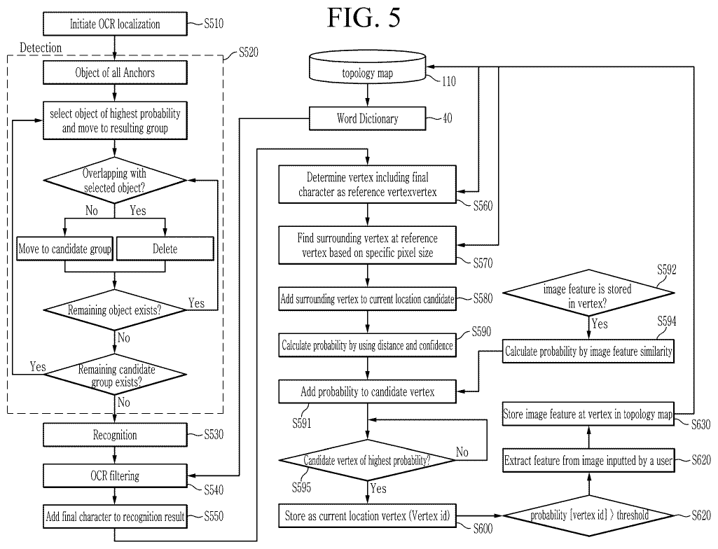

FIG. 5 is a flowchart of a topology map-based user location estimation method. Hereinafter, description will be made with reference to FIG. 1 and FIG. 2. The topology map-based user location estimation method can be performed through the topology map-based user location estimation apparatus 100.

The topology map-based user location estimation apparatus 100 can initiate an OCR-based user location estimation method at step S510, and first, can perform the character recognition and character position detection on the user input image through the OCR module 120.

The OCR module 120 can be a module configured to extract characters from an image by using deep learning. The optical character recognition (OCR) module 120 can be configured of generally two modules of a character position detection module and a character recognition module.

At step S520, the character position detection module can detect the position of the recognized character from the user's surrounding image.

The character position detection module can utilize the anchor-based deep neural network (DNN) structure in order to estimate the position of character existing in the image, and can go through a non-maximum suppression (NMS) process, for post-processing.

The anchor defines a region in an image where the object can exist in advance, and then, for each anchor region, can infer the probability of the existence of the object and the shape of the object by utilizing a DNN structure. At this time, since a plurality of anchors can exist within one object, a post-processing procedure so called NMS is processed in order to use an inference result of an anchor having a highest probability. The NMS calculates an overlapping level between the object of the anchor having the highest probability and objects of other anchors, and can perform the process of considering the objects of anchors overlapping by a preset level or above as being detected as actually the same object and thereby deleting it.

At step S530, the character recognition module can recognize the characters from the user's surrounding image.

The character recognition module can receive the character region detected by the character position detection module as an input, and can recognize which character is indicated by the corresponding character. Because there is not prior information on the length of the character, the character recognition module can recognize the character can recognize the given character by splitting the character image into a plurality of successive patches and recognizing the content of the successive patches.

The character recognition module can utilize a long short-term memory (LSTM) structure for the inference on successive inputs, and the length of the input character is variable, a special letter of BLANK can be introduced and utilized.

The character recognition module can utilize Connectionist Temporal Classification (CTC) technique in order to perform training for variable characters, and the CTC can perform learning on sequences of all available combinations, including the BLANK letter.

The OCR module 120 may not only finally recognize the character from the image by utilizing the character position detection module and the character recognition module but also output the coordinate of the pixel where the character is located and the confidence value of a final recognition result as the results.

At step S540, the OCR filter 130 can retrieve the word dictionary 40 from the topology map, compare it with the results currently recognized by the OCR module 120, and select only the results helpful for finding the user location as the final character.

The OCR filter 130 can improve the route finding performance, and can perform a filtering process in order to filter only necessary characters from among the recognition results of the OCR, in order to reduce the amount of calculation. The characters existing in the word dictionary stored in the topology map can configure words providing the location information on positions on the topology map.

The OCR filter 130 can retrieve the word providing the location information from the topology map (or word dictionary), and can compare similarity with the character recognized by the OCR module 120.

At step S550, the OCR filter 130 can add only the character having the similarity greater than or equal to a specific level to the recognition result. That is, the recognition result can include the final character to be used for the detection of the current location of the user.

The OCR filter 130 can utilize a measurement reference or edit distance algorithm referred to as Edit Distance in order to compare similarity between two characters. Edit Distance can measure how many times three operations of deletion, insertion, and adjustment need to be performed in order for two characters to become the same character.

In the case of Korean, unlike English, one letter can be made of pluralities of vowels and consonants, and therefore, before performing the Edit Distance, the OCR filter 130 can perform the pre-processing process of decomposing vowels and consonants of characters.

When the distance is measured by the function Edit Distance, in order to normalize it, it can be normalized by a length of a character having a greater length among two characters and can be used as the similarity of the character.

This can be defined as Equation 1 below.

$$Similarity ( character 1 , character 2 ) = 1 - \frac{Edit Distance ( character 1 , character 2 )}{Max ( L ( character 1 ) , L ( character 2 ) )} \qquad [ Equation 1 ]$$

Here, character1 denotes characters recognized by OCR in the user's surrounding image, character2 denotes the location information stored in the topology map, Edit Distance denotes an edit distance algorithm measuring similarity between character1 and character2, and L is a function for obtaining the length of respective characters.

Example 1 of the similarity calculation of the OCR filter 130 is as follows.
(Example 1) character1=“ [symbol] ”, character2=“ [symbol] ”

### 1 Decomposition of Vowels and Consonants;

Character1=“ [symbol] ”
Character2=“ [symbol] ”

### 2 Calculation of Edit Distance;

Character1=“ [symbol] ”
Character2=“ [symbol] ”

In Example 1, since 3 times of corrections are required in order for the two characters become identical, the Edit distance value can be come 3.

### 3 Calculation of Max Length;

Length of character1=8
Length of character2=8

### 4 Calculation of Similarity;

Since 1−(3/8)=0.625 is satisfied, the similarity between character1 and character2 in Example 1 can be calculated as 0.625.

Example 2 of the similarity calculation of the OCR filter 130 is as follows.
(Example 2) character 1= [symbol] “, character2=“ [symbol] ””

### 1 Vowel, Consonant Decomposition Step;

Character1=“ [symbol] ”
Character2=“ [symbol] ”

### 2 Edit Distance Calculation Step;

Character1=“ [symbol] ”
Character2=“ [symbol] ”

Since 4 times of corrections and 2 times of insertions are required in order for the two characters become identical, the Edit distance value can become 6.

### 3 Calculation of Max Length;

Length of character1=6
Length of character2=8

### 4 Calculation of Similarity Calculation;

Since 1−(6/8)=0.25 is satisfied, the similarity between character1 and character2 in Example 2 can be calculated as 0.25.

The location finding module 140 can be a module for finding a vertex having a highest probability of being the user current location from among vertices stored in the topology map 110 by using the recognition results determined be meaningful by the OCR filter 130.

At step S560, the location finding module 140 can detect the reference vertex where the word or the location information matched in the topology map is stored, by using word matching the final character included in the recognition result.

At step S570, the location finding module 140 can detect the surrounding vertices within the predetermined distance around the reference vertex. The predetermined distance can be determined as the size of the pixel unit.

Here, the criterion of the predetermined distance can be determined proportional to a size of the guide map image 10 (see FIG. 1).

The location finding module 140 can consider the surrounding vertices as the current location candidate of the user at step S580, and can calculate the probability for each candidate vertex. Here, the probability can correspond to the probability that the candidate vertex is determined as the actual current the location of the user.

At step S590, the location finding module 140 can calculate probability by using a distance from the reference vertex of the candidate vertex and a confidence of the final recognition result obtained from the OCR module 120. At step S591, the location finding module 140 can add the calculated probabilities to the candidate vertices, respectively.

Here, the confidence can mean the confidence with respect to the results of recognizing the character by the OCR module 120, and the reason why the confidence is used in calculating the probability is that the confidence with respect to the results recognized by the OCR can be reflected when many characters are simultaneously recognized.

The location finding module 140 can calculated the probability by using Equation 2 below.

$$Probability = \frac{( number of reference pixels - distance to vertez storing word )}{number of reference pixels} \times confidence \qquad [ Equation 2 ]$$

Here, “the number of reference pixels” represents the predetermined distance between the reference vertex and the surrounding vertex, “distance to vertex storing word” represents a distance of the corresponding current location candidate to the reference vertex, and “confidence” represents the confidence of the OCR recognition result.

At this time, at step S592, when there are a specific number or more of surrounding images registered in the surrounding vertices, and the feature of the surrounding image is stored in the surrounding vertex, at step S594, the location finding module 140 can calculate similarity between the user's surrounding image feature and a registered the surrounding image feature and reflect it to the probability.

Here, the image feature can include a character included in the image, an image around word, and position and location information.

At step S600, the location finding module 140 can calculate the probability of the candidate vertices estimated as current locations with respect to all the recognition results, and then notify the user that the candidate vertex of highest probability is estimated as the actual current the location of the user.

When the probability is higher than a predetermined threshold value at step S610, the location finding module 140 can extract the feature including the location information from the corresponding surrounding image at step S620, and can register the extracted image feature to the corresponding vertex of the topology map 110 at step S630.

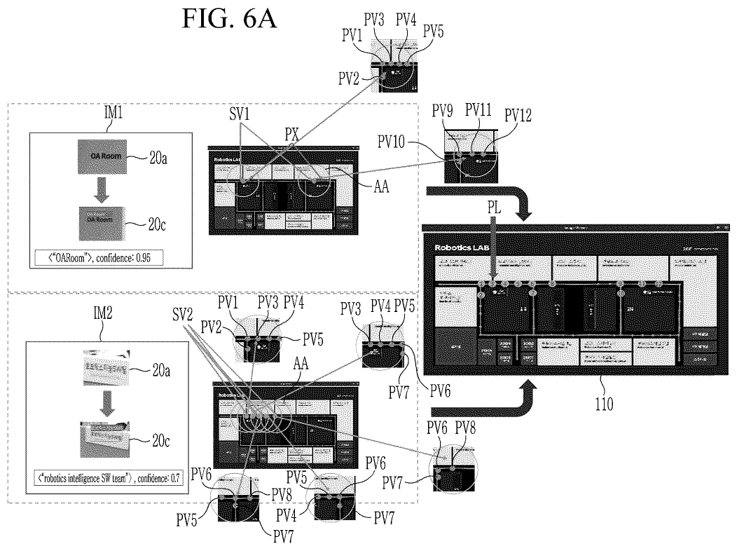

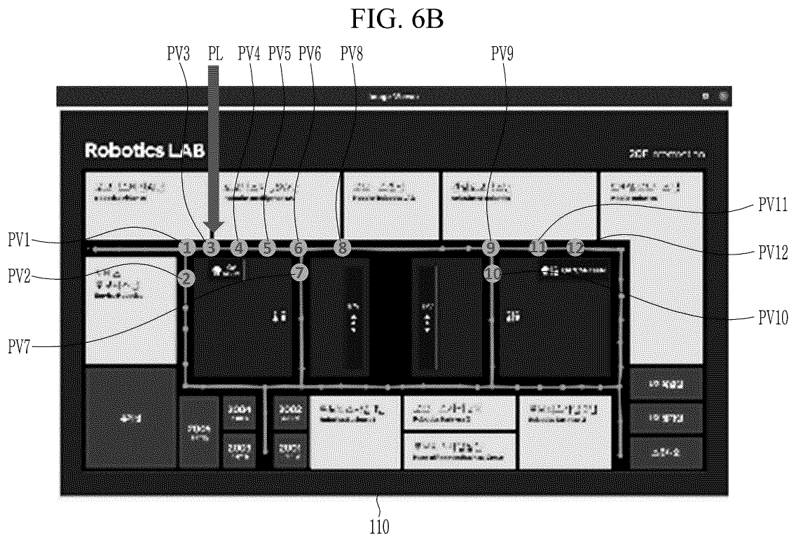

FIG. 6A and FIG. 6B are example diagrams for explaining a topology map-based user location estimation method. FIG. 6A is a drawing showing an example of a topology map-based user location estimation method, and FIG. 6B is a drawing showing an enlarged version of the topology map 110 including the estimated user location of FIG. 6A.

In FIG. 6A and FIG. 6B, the topology map-based user location estimation apparatus 100 can receive a plurality of surrounding images 20a of the user according to the user input.

The topology map-based user location estimation apparatus 100 can obtain a recognition result 20c through the OCR module 120 (see FIG. 2) and the OCR filter 130 (see FIG. 2), with respect to each of two user's surrounding images 20a.

The topology map-based user location estimation apparatus 100 can obtain both the final character and a confidence of the final character recognition as the recognition results.

For example, the confidence with respect to a first image IM1 can be 0.95, and the confidence with respect to a second image IM2 can be 0.7.

The topology map-based user location estimation apparatus 100 can detect two first reference vertices SV1 where the character “OA room” of the first image IM1 is stored from the topology map 110.

The topology map-based user location estimation apparatus 100 can determine surrounding vertices PV1 to PV5 and PV9 to PV12 within the predetermined distance region AA from each of first reference vertices SV1 with the number of reference pixels PX.

The topology map-based user location estimation apparatus 100 can detect five second reference vertices SV2 where the character “robotics intelligence SW team” of the second image IM2 is stored from the topology map 110.

The topology map-based user location estimation apparatus 100 can determine the surrounding vertices PV1 to PV8 within the predetermined distance region AA from each of the second reference vertices SV2 with the number of reference pixels PX.

The topology map-based user location estimation apparatus 100 can calculate a total probability as a sum of the probabilities detected from the first and second images IM1 and IM2, with respect to each of the candidate vertices each, respectively.

Each probability can be calculated through Equation 2 below.

$$Probability = \frac{( number of reference pixels - distance to vertez storing word )}{number of reference pixels} \times confidence \qquad [ Equation 2 ]$$

Hereinafter, the number of reference pixels can be assumed as 10. The confidence can 0.95 and 0.7, be respectively.

For example, the total probability of a candidate vertex1 PV1 can be calculated as a sum 0.965 of the probability 0.475 detected based on the first reference vertex SV1 and the probability 0.49 detected based on the second reference vertex SV2.

Here, the probability of the candidate vertex1 PV1 based on the first reference vertex SV1 can be calculated as 10-9/10×0.95, resulting 0.475, and the probability of the candidate vertex1 PV1 based on the second reference vertex SV2 can be calculated as 10-3/10×0.7, resulting 0.49. Hereinafter, specific calculation process will not be described in detail.

The total probability of a candidate Vertex 2 PV2 can be calculated as 0.095. The total probability of a candidate vertex 3 PV3 can be calculated as 0.95+0.7+0.49=2.14. The total probability of a candidate vertex 4 PV4 can be 0.475+0.42+0.7+0.49=2.095, the total probability of a candidate vertex 5 PV5 can be 0.095+0.07+0.42+0.7+0.21=1.495, the total probability of a candidate vertex 6 PV6 can be 0.14+0.49+0.7+0.21=1.54, the total probability of a candidate vertex 7 PV7 can be 0.07+0.28+0.14+0.56=1.05, the total probability of a candidate vertex 8 PV8 can be 0.7+0.35=1.05, the total probability of a candidate vertex 9 PV9 can be 0.19, the total probability of a candidate vertex10 PV10 can be 0.095, the total probability of a candidate vertex11 PV11 can be 0.95, and the total probability of a candidate vertex12 PV12 can be 0.57.

The topology map-based user location estimation apparatus 100 can determine the candidate vertex (current location candidate) of which the total probability is greatest, as final vertex or actual user current location.

In FIG. 6A and FIG. 6B, the total probability of the candidate vertex 3 PV3 can be 2.14, which is highest among the probabilities of the candidate vertices PV1 to PV12. Therefore, the topology map-based user location estimation apparatus 100 can detect the candidate vertex 3 PV3 on the topology map 110 as the actual user current location PL.

By utilizing the present disclosure, since the advantage that the change of the topology map can be promptly reflected can be utilized, the current location finding service can be provided to the users at a low cost in fairs, conferences, and exhibition halls held for a short period of time or indoor environment having many stores having frequently changing surrounding environment.

Such services can improve the satisfaction of the users on the event. Even when outsiders are invited to an event, this service can be provided so that the invited guest may not get lost.

The topology map can be created with respect to not only indoor areas but also in outdoor company facilities, factories, research complexes, apartments, hiking trails, and military facilities that are not disclosed in the map app, which allows officials and visitors to easily find their way around large outdoor spaces. In addition, since the method of the present disclosure is a method of estimating the current location using an image, a foreigner can find his/her current location by using a Korean sign board, and when the service is provided in a foreign country, a Korean can find the current location in wide indoor space by using this service without knowing the language of that country.

Because there is space recognition information composed of characters in the topology map, the topology map can be updated by extracting features from efficiently input image.

When the image features are sufficiently stored in the topology map, the location estimation result of high confidence can be notified to the user, and at the same time, robots can also utilize the topology map to enable autonomous driving, thereby enabling provision of various services.

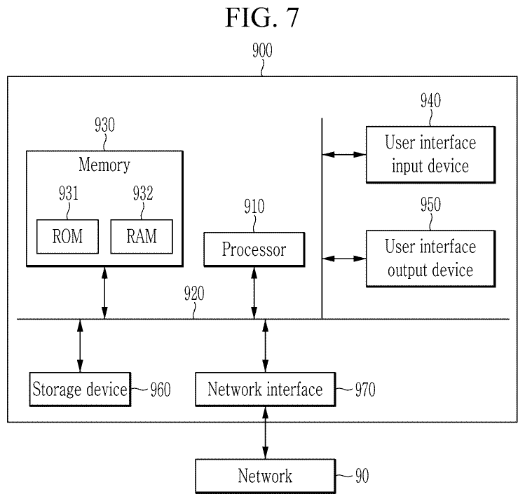

FIG. 7 is a drawing for explaining a computing device.

Referring to FIG. 7, a topology map-based user location estimation apparatus and method can be implemented by using a computing device 900.

The computing device 900 can include at least one of a processor 910, a memory 930, the user interface input device 940, the user interface output device 950 and a storage device 960 that communicate through a bus 920. The computing device 900 can also include a network interface 970 electrically connected to a network 90. The network interface 970 can transmit or receive signals with other entities through the network 90.

The processor 910 can be implemented in various types such as a micro controller unit (MCU), an application processor (AP), a central processing unit (CPU), a graphic processing unit (GPU), a neural processing unit (NPU), and the like, and can be any type of semiconductor device capable of executing instructions stored in the memory 930 or the storage device 960. The processor 910 can be configured to implement the functions and methods described above with respect to FIG. 1 to FIG. 6b.

The memory 930 and the storage device 960 can include various types of volatile or non-volatile storage media. For example, the memory can include read-only memory (ROM) 931 and a random-access memory (RAM) 932. In some examples, the memory 930 can be located inside or outside processor 910, and the memory 930 can be connected to the processor 910 through various known means.

In some implementations, at least some configurations or functions of a topology map-based user location estimation apparatus and method can be implemented as a program or software executable by the computing device 900, and program or software can be stored in a computer-readable medium.

In some implementations, at least some configurations or functions of a topology map-based user location estimation apparatus and method can be implemented by using hardware or circuitry of the computing device 900, or can also be implemented as separate hardware or circuitry that can be electrically connected to the computing device 900.

While this disclosure has been described in connection with what is presently considered to be practical implementations, it is to be understood that the disclosure is not limited to the disclosed implementations, but, on the contrary, is intended to cover various modifications and equivalent arrangements included within the spirit and scope of the appended claims.

### DESCRIPTION OF SYMBOLS

10: guide map image
100: topology map-based user location estimation apparatus
110: topology map
120: OCR module
130: OCR filter
140: location finding module

What is claimed is:

1. A topology map-based user location estimation apparatus, comprising:
an Optical Character Recognition (OCR) module configured to recognize characters from an image of an environment surrounding a user;
an OCR filter configured to, based on a similarity determination with location information that is stored in a topology map, filter one or more characters from the recognized characters, the topology map being generated based on a guide map image; and
a location finding module configured to, based on the filtered one or more characters, detect a current location of the user on the topology map.

2. The topology map-based user location estimation apparatus of claim 1, wherein the OCR module is configured to, based on a utilization of an artificial intelligence, (i) detect the characters and a respective coordinate of a pixel where one or more of the characters is located, and (ii) determine a confidence level of an OCR recognition result regarding the image.

3. The topology map-based user location estimation apparatus of claim 2, wherein the topology map comprises a vertex that stores the location information and an edge that connects the vertex to another vertex.

4. The topology map-based user location estimation apparatus of claim 3, wherein the location finding module is configured to extract, from vertices of the topology map, a vertex that is estimated as the current location of the user.

5. The topology map-based user location estimation apparatus of claim 4, wherein the OCR filter is configured to detect similarity of the location information between the recognized characters and the topology map through Equation 1 below,
$$Similarity ( character 1 , character 2 ) = 1 - \frac{Edit Distance ( character 1 , character 2 )}{Max ( L ( character 1 ) , L ( character 2 ) )} \qquad [ Equation 1 ]$$
wherein character1 denotes the recognized characters,
wherein character2 denotes the location information stored in the topology map,
wherein Edit Distance denotes an edit distance algorithm that determines similarity between character1 and character2, and
wherein L is a function for obtaining a length of the character1 or the character 2.

6. The topology map-based user location estimation apparatus of claim 5, wherein the OCR filter is configured to identify, as a final character, a character with a detected similarity that is greater than or equal to a preset threshold.

7. The topology map-based user location estimation apparatus of claim 6, wherein the location finding module is configured to (i) identify, as a reference vertex, a vertex on the topology map that has location information matching the final character, and (ii) determine a plurality of surrounding vertices that are within a predetermined distance from the reference vertex.

8. The topology map-based user location estimation apparatus of claim 7, wherein the location finding module is configured to determine the predetermined distance in proportion to a size of the guide map image.

9. The topology map-based user location estimation apparatus of claim 7, wherein the location finding module is configured to identify the surrounding vertices as current location candidates of the user, and determine, by using Equation 2 below, a probability for each of the current location candidates, respectively,
$$Probability = \frac{( number of reference pixels - distance to vertez storing word )}{number of reference pixels} \times confidence \qquad [ Equation 2 ]$$
wherein the probability represents a likelihood that the current location candidate corresponds to the current location,
wherein a number of reference pixels represents the predetermined distance between the reference vertex and surrounding vertex of the surrounding vertices,
wherein a distance to vertex storing word represents a distance from a corresponding current location candidate to the reference vertex, and
wherein a confidence represents the confidence level of the OCR recognition result.

10. The topology map-based user location estimation apparatus of claim 9, wherein the location finding module is configured to identify, among the surrounding vertices identified as the current location candidates, a vertex having the highest probability as the current location of the user.

11. A topology map-based user location estimation method, comprising:
providing a topology map that is generated based on a guide map image;
recognizing characters from an image of an environment surrounding a user;
filtering, based on a similarity determination with location information stored in the topology map, one or more characters from the recognized characters to thereby obtain a final character; and
detecting a current location of the user on the topology map based on the final character.

12. The topology map-based user location estimation method of claim 11, wherein recognizing the characters comprises:
based on a utilization of an artificial intelligence, (i) detecting the characters and a respective coordinate of a pixel where one or more of the characters is located, and (ii) determining a confidence level of an OCR recognition result regarding the image.

13. The topology map-based user location estimation method of claim 12, wherein the topology map comprises a vertex that stores the location information and an edge that connects the vertex to another vertex.

14. The topology map-based user location estimation method of claim 13, wherein detecting the current location of the user comprises:
extracting, from vertices of the topology map, a vertex that is estimated as the current location of the user.

15. The topology map-based user location estimation method of claim 14, wherein filtering the one or more characters from the recognized characters comprises:
detecting similarity of the location information between the recognized characters and the topology map through Equation 1 below:
$$Similarity ( character 1 , character 2 ) = 1 - \frac{Edit Distance ( character 1 , character 2 )}{Max ( L ( character 1 ) , L ( character 2 ) )} \qquad [ Equation 1 ]$$
wherein character1 denotes the recognized characters,
wherein character2 denotes the location information stored in the topology map,
wherein Edit Distance denotes an edit distance algorithm that determines similarity between character1 and character2, and
wherein L is a function for obtaining a length of the character1 or the character 2.

16. The topology map-based user location estimation method of claim 15, wherein filtering the one or more characters from the recognized characters comprises:
identifying, as the final character, a character with a detected similarity that is greater than or equal to a preset threshold.

17. The topology map-based user location estimation method of claim 16, wherein the detecting the current location of the user comprises:
identifying, as a reference vertex, a vertex on the topology map that has location information matching the final character, and
determining a plurality of surrounding vertices that are within a predetermined distance from the reference vertex.

18. The topology map-based user location estimation method of claim 17, wherein the detecting the current location of the user comprises:
determining the predetermined distance in proportion to a size of the guide map image.

19. The topology map-based user location estimation method of claim 17, wherein the detecting the current location of the user comprises:
identifying the surrounding vertices as current location candidates of the user, and
determining, by using Equation 2 below, a probability for each of the current location candidates:
$$Probability = \frac{( number of reference pixels - distance to vertez storing word )}{number of reference pixels} \times confidence \qquad [ Equation 2 ]$$
wherein the probability represents a likelihood that the current location candidate corresponds to the current location,
wherein a number of reference pixels represents the predetermined distance between the reference vertex and surrounding vertex of the surrounding vertices,
wherein a distance to vertex storing word represents a distance from a corresponding current location candidate to the reference vertex, and
wherein a confidence represents the confidence level of the OCR recognition result.

20. The topology map-based user location estimation method of claim 19, wherein detecting the current location of the user comprises:
identifying, among the surrounding vertices identified as the current location candidates, a vertex having the highest probability as the current location of the user.
